(19) United States
(12) Patent Application Publication
(10) Pub. No.: US 2015/0198807 A1
(43) Pub. Date: Jul. 16, 2015

(54) HEAD-MOUNTED DISPLAY DEVICE AND OPTICAL UNIT

(71) Applicant: Sony Corporation, Tokyo (JP)

(72) Inventor: Shinji Hirai, Tokyo (JP)

(21) Appl. No.: 14/409,586

(22) PCT Filed: May 14, 2013
(86) PCT No.: PCT/JP2013/063369

§ 371 Date: Dec. 19, 2014

(30) Foreign Application Priority Data
Jul. 4, 2012 (JP) 2012-150702

(51) Int. Cl. G02B 27/01

(52) U.S. Cl. CPC G02B 27/0172; G02B 2027/0178

(57) ABSTRACT

Provided is a head-mounted display apparatus including a display panel portion including a display panel configured to display an image, an ocular optical portion having a lens integrally formed with an attaching part to which the display panel portion is attached, and configured to perform optical processing for a video displayed by the display panel, a video signal processing portion configured to process a video signal, and a display controlling portion configured to drive the display panel based on the video signal processed at the video signal processing portion.

### TECHNICAL FIELD

The technology disclosed in the present specification relates to a head-mounted display apparatus and an optical unit to be used by mounting them on the head of a user, and in particular a head-mounted display apparatus and an optical unit having a display panel for displaying a video and an ocular optical portion for projecting the image displayed on the display panel into user's eyes.

### BACKGROUND ART

There is widely known a displaying apparatus mounted on a head to view a video, that is, a head mount display (HMD). The head mount display has an optical unit for each of right and left eyes and is configured to be able to control the senses of sight and hearing when it is used with headphones. When it is configured so as to be completely cut off from the outside world at the time it is attached to the head, the virtual reality is increased at the time of looking and listening. Also, the head mount display can reflect different videos to right and left eyes, and, when images with disparity are displayed to the right and left eyes, it is possible to present a 3D image.

A head mount display is a display system that provides a user with a virtual image (i.e., that forms a virtual image on the retina of the eye). Here, the virtual image is the one which, when an object is located closer to a lens compared to the focal length, is formed on the side of the object.

In a case where a user appreciates a virtual image, it is preferable, for example, to vary the length from the user at which a virtual image is formed, depending on videos. For example, there is proposed a head-mounted liquid crystal display apparatus which is compact and light weight using small liquid crystal display elements being 2 inches or less in diagonal and has a wider viewing angle, achieved with a magnifying lens composed of three high refractive index plastic lenses (refer to, e.g., Patent Literature 1).

Also, there is proposed a display apparatus which provides a virtual image in a form suitable to a video (refer to, e.g., Patent Literature 2). This display apparatus is provided with a magnifying optical system in which the same virtual image observed by the left eye and the right eye of a user is disposed on the same plane, and is configured to control the distance of the virtual image from the user and the size of the virtual image, depending on the aspect ratio of videos. For example, videos such as movies and dramas with an aspect ratio of 16:9 according to the high-vision broadcasting are formed on the retinas as a larger virtual image at a distant location about 15 meters away from a user, whereas videos of television signals with an aspect ratio of 4:3 according to National Television System Committee (NTSC) system are formed on retinas as a middle size virtual image at a relatively close location about 3 meters away from a user, thereby allowing a user to feel a realistic sensation as well as decreasing a tired feeling at the time of appreciating a virtual image.

If high-resolution elements such as organic electro-luminescence (EL) are used for the displaying portions for right and left eyes of a head mount display while a suitable field angle is set in an optical system, and also a multichannel is reproduced with a headphone, then such a realistic sensation as to be viewed in a movie theater will be able to be reproduced. The present applicant aims to have a head mount display capable of providing a viewing environment that is equal to the best seat in a movie theater.

If, in a head mount display, right and left optical axes of an optical system are not coincident with each other with high precision, then an observing user ends up feeling uncomfortable with the video. In order to allow the right and left optical axes to be coincident with each other, it is general to adjust the positions of right and left displaying portions such that a video to be observed is coincident with an adjustment index. For example, there is proposed a head-mounted video display apparatus with no or reduced need of adjustment of optical axes of liquid crystal display elements, achieved by mounting the liquid crystal display elements on a holding member after performing corresponding positional adjustment around X, Y and ω axes, and then attaching the holding member with the liquid crystal display elements fixed thereon to an optical unit with an ocular lens housed therein (refer to, e.g., Patent Literature 3).

The present applicant considers that, in order to meet the required precision as a head mount display, it is necessary to position and fix a display panel depending on optical properties of a lens. The positioning precision of a display panel relative to a lens must be at least a pixel size (e.g., 10μ in the case of using organic electro-luminescent (EL) elements) or less.

However, it is difficult to meet the aforementioned required precision with mechanical positioning such as, for example, abutting and hole-mating. Furthermore, in order to realize a structure that meets the aforementioned required precision with the mechanical positioning, higher precision of components and management according to the precision are required, causing increased costs of components and increased assembly costs.

For example, there is proposed a compact and lightened head mount display, achieved by integrally molding a substrate of a liquid crystal display panel main body and an ocular lens (refer to, e.g., Patent Literature 4). However, if the substrate of the liquid crystal display panel main body and the ocular lens are made integral, then the positioning precision of the liquid crystal display panel main body and the optical axis of the ocular lens is fixed at the time of molding, making it impossible to further perform positional adjustment with high precision. Furthermore, it is considered that, when an ocular optical system is composed of a plurality of lenses, it is difficult to integrally mold a plurality of ocular lenses with a liquid crystal display panel main body being included.

### CITATION LIST

### Patent Literature

Patent Literature 1: JP H9-113823A

Patent Literature 2: JP 2007-133415A

Patent Literature 3: JP 2008-249869A, paragraph [0030]

Patent Literature 4: JP H8-278476A

### SUMMARY OF INVENTION

### Technical Problem

The purpose of the technology disclosed in the present specification is to provide an excellent head-mounted display apparatus and an optical unit, provided with a display panel for displaying a video and an ocular lens for projecting the image displayed on the display panel into user's eyes, and configured such that the display panel can be precisely aligned depending on optical properties of the ocular lens.

### Solution to Problem

The present disclosure has been achieved in view of the above problem, and the first aspect of the present disclosure provides a head-mounted display apparatus including a display panel portion including a display panel configured to display an image, an ocular optical portion having a lens integrally formed with an attaching part to which the display panel portion is attached, and configured to perform optical processing for a video displayed by the display panel, a video signal processing portion configured to process a video signal, and a display controlling portion configured to drive the display panel based on the video signal processed at the video signal processing portion.

According to the second aspect of the present disclosure, the lens having the attaching part of the head-mounted display apparatus according to the first aspect is made of a transparent resin-molded lens, with which the attaching part is integrally molded.

According to the third aspect of the present disclosure, the attaching part of the head-mounted display apparatus according to the second aspect includes a plurality of fixing pins integrally molded with the transparent resin-molded lens. The fixing pin is inserted through a fixing hole bored on a side of the display panel portion to attach the display panel portion to the ocular optical portion.

According to the fourth aspect of the present disclosure, in the head-mounted display apparatus according to the third aspect, the fixing pin is provided at a location where no light of a video displayed on an effective area of the display panel passes through on a surface of the transparent resin-molded lens.

According to the fifth aspect of the present disclosure, in the head-mounted display apparatus according to the third aspect, the plurality of fixing pins are provided at locations that are symmetrical with respect to an optical center of the transparent resin-molded lens.

According to the sixth aspect of the present disclosure, the ocular optical portion of the head-mounted display apparatus according to the first aspect has a plurality of lenses, and the lens which is integral with the attaching part is the most adjacent to the display panel.

According to the seventh aspect of the present disclosure, the head-mounted display apparatus according to the first aspect further includes a display panel cooling portion configured to cool the display panel.

According to the eighth aspect of the present disclosure, the display panel cooling portion of the head-mounted display apparatus according to the seventh aspect has a heat sink configured to be brought into surface contact with a substrate side of the display panel.

According to the ninth aspect of the present disclosure, the head-mounted display apparatus according to the eighth aspect further includes a heat conductive grease configured to fill a gap that occurs at a time of bringing the heat sink into surface contact with the substrate side of the display panel.

According to the tenth aspect of the present disclosure, the head-mounted display apparatus according to the first aspect further includes a display panel sealing portion configured to seal a light-emitting face of the display panel.

According to the eleventh aspect of the present disclosure, the display panel sealing portion of the head-mounted display apparatus according to the tenth aspect has a cover frame configured to cover a side part of the display panel fixed by the display panel holding portion, and a lid portion configured to close an opening of the cover frame.

According to the twelfth aspect of the present disclosure, in the head-mounted display apparatus according to the eleventh aspect, the lid portion is the heat sink configured to be brought into surface contact with a substrate side of the display panel.

According to the thirteenth aspect of the present disclosure, the head-mounted display apparatus according to the twelfth aspect further includes a heat conductive grease configured to fill a gap that occurs at a time of bringing the heat sink into surface contact with the substrate side of the display panel.

The invention according to the fourteenth aspect of the present disclosure provides an optical unit for a head-mounted display apparatus including a display panel portion including a display panel configured to display an image, and an ocular optical portion having a lens integrally formed with an attaching part to which the display panel portion is attached, and configured to perform optical processing for a video displayed by the display panel.

### Advantageous Effects of Invention

According to the technology disclosed in the present specification, there can be provided an excellent head-mounted display apparatus and an optical unit, provided with a display panel for displaying a video and an ocular lens for projecting the image displayed on the display panel into user's eyes, and configured such that the display panel can be precisely aligned depending on optical properties of the ocular lens.

According to the technology disclosed in the present specification, there can be provided an excellent head-mounted display apparatus and an optical unit, configured such that a display panel can be aligned relative to an ocular lens with such precision as to be the pixel size of the display panel or less without impairing compactness and light weight.

Still other purposes, features and advantages of the technology disclosed in the present specification will be clarified by more detailed description based on the following embodiments and accompanying drawings.

### BRIEF DESCRIPTION OF DRAWINGS

FIG. 1 is a diagram schematically illustrating the configuration of an image display system including a head mount display.

FIG. 2 is a diagram illustrating the appearance of the top face of a head mount unit 10 main body from above.

FIG. 3 is a diagram schematically illustrating the internal configuration of a head mount unit 10.

FIG. 4 is a diagram for explaining the method of how to position and fix a display panel on a lens tube via a panel holder.

FIG. 5 is a diagram for explaining the method of how to position and fix a display panel on a lens tube via a panel holder.

FIG. 6 is a diagram for explaining the method of how to position and fix a display panel on a lens tube via a panel holder.

FIG. 7 is a diagram for explaining the method of how to position and fix a display panel on a lens tube via a panel holder.

FIG. 8 is a diagram for explaining the method of how to position and fix a display panel on a lens tube via a panel holder.

FIG. 9 is a diagram for explaining the method of how to position and fix a display panel on a lens tube via a panel holder.

FIG. 10 is a diagram illustrating the top face of a transparent resin-molded lens with a fixing pin being integrally molded therewith.

FIG. 11 is a diagram illustrating the structure in which a display panel is directly positioned and fixed using fixing pins integrally molded with a transparent resin-molded lens.

FIG. 12 is a diagram for explaining the method of how to directly position and fix a display panel using fixing pins integrally molded with a transparent resin-molded lens.

FIG. 13 is a diagram for explaining the method of how to directly position and fix a display panel using fixing pins integrally molded with a transparent resin-molded lens.

FIG. 14 is a diagram for explaining the method of how to directly position and fix a display panel using fixing pins integrally molded with a transparent resin-molded lens.

FIG. 15 is a diagram illustrating the appearance in which a cover frame 1104 is attached to a lens tube of an ocular optical lens portion 1101.

### DESCRIPTION OF EMBODIMENTS

Hereinafter, embodiments of the technology disclosed in the present specification will be described in detail with reference to the drawings.

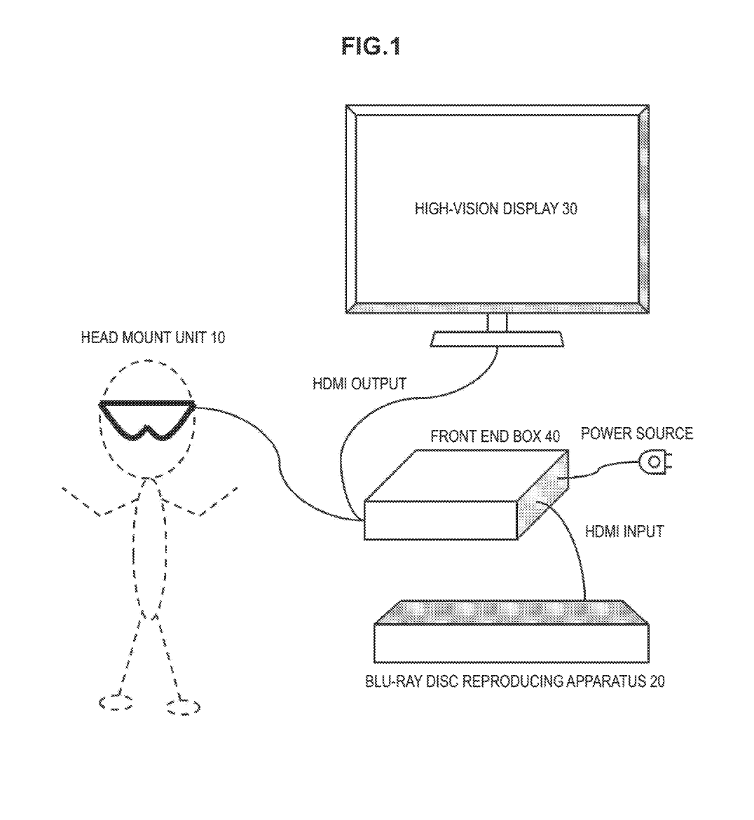

FIG. 1 schematically illustrates the configuration of an image display system including a head mount display. The illustrated system is composed of a Blu-ray disc reproducing apparatus 20 which is a source of viewing contents, a front end box 40 for processing an AV signal output from the Blu-ray disc reproducing apparatus 20, a head-mounted display apparatus (head mount unit) 10 which is an output destination of the reproduced contents of the Blu-ray disc reproducing apparatus 20, and a high-vision display (e.g., HDMI (registered trademark) compatible television) 30 which is another output destination of the reproduced contents of the Blu-ray disc reproducing apparatus 20. The head mount unit 10 and the front end box 40 constitute one set of a head mount display.

The front end box 40 corresponds to an HDMI (registered trademark) repeater that, when receiving an HDMI (registered trademark) input of an AV signal output from the Blu-ray disc reproducing apparatus 20, performs signal processing and HDMI (registered trademark) output, for example. Also, the front end box 40 also denotes a two-way output switcher that switches the output destination of the Blu-ray disc reproducing apparatus 20 to one of the head mount unit 10 and the high-vision display 30. In the illustrated example, although the front end box 40 has two outputs, it may have three outputs or more. However, in the front end box 40, the output destination of AV signals is exclusive and the highest priority is assigned to an output to the head mount unit 10.

It is noted that High-Definition Multimedia Interface (HDMI (registered trademark)) is an interface standard which is formed based on a Digital Visual Interface (DVI), includes a physical layer of Transition Minimized Differential Signaling (TMDS), and is used for a digital home electric appliance which is mainly used for transmitting sounds and videos. The present system conforms to HDMI (registered trademark) 1.4, for example.

An HDMI (registered trademark) cable connects between the Blu-ray disc reproducing apparatus 20 and the front end box 40 and between the front end box 40 and the high-vision display 30. Although it is possible to employ a configuration in which an HDMI (registered trademark) cable connects between the front end box 40 and the head mount unit 10, cables of other specifications may be used to perform serial transfer of AV signals. However, it is assumed that AV signals and power are supplied by one cable connecting between the front end box 40 and the head mount unit 10, and the head mount unit 10 can acquire drive power through this cable.

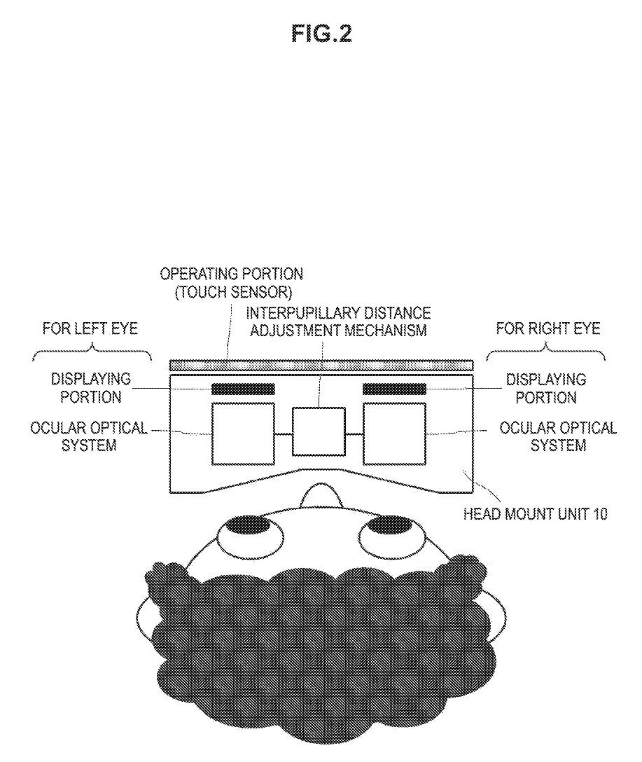

FIG. 2 illustrates the appearance of the top face of a head mount unit 10 main body from above.

The head mount unit 10 is provided with two independent displaying portions for the left eye and the right eye. Each of the displaying portions employs a display panel composed of organic electro-luminescent (EL) elements, for example. Furthermore, each of the right and left displaying portions is equipped with a wide viewing angle ocular optical system with low distortion and high resolution. If a video on the display panel is enlarged and projected with this ocular optical system to set a wider field angle while a multichannel is reproduced with a headphone, then such a realistic sensation as to be viewed in a movie theater can be reproduced.

The head mount unit 10 has an optical system independently for the right and left sides, while the eye level and interpupillary distance vary individually for each user, and thus it is required to align the optical systems and the eyes of a user who wears it. Therefore, the head mount unit 10 main body portion is equipped with an interpupillary distance adjustment mechanism for adjusting interpupillary distance between a displaying portion for the right eye and a displaying portion for the left eye.

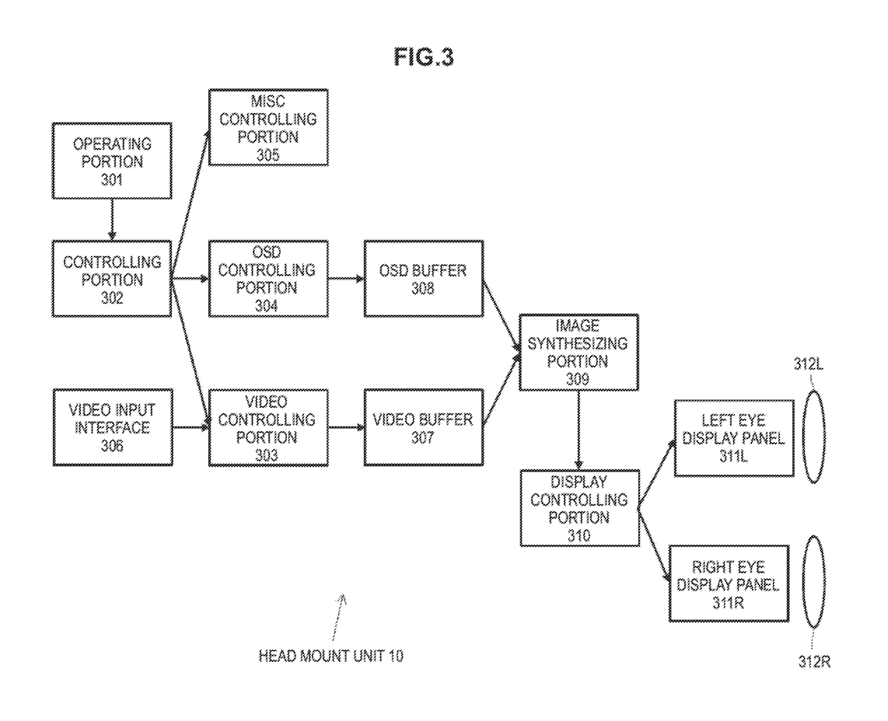

FIG. 3 schematically illustrates the internal configuration of a head mount unit 10. Hereinafter, each portion will be explained.

An operating portion 301 is provided with operators such as a touch sensor, a button, and a key (e.g., power button and cross key, any of which is not illustrated). A controlling portion 302 comprehensively controls actions inside the head mount unit 10 depending on the control information via the operating portion 301. Specifically, the controlling portion 302 instructs a video controlling portion 303 to process video signals, instructs an OSD controlling portion 304 to draw an OSD screen, and instructs an MISC controlling portion 305 to perform various actions inside equipment.

A video input interface 306 inputs video signals reproduced and output from the Blu-ray disc reproducing apparatus 20 (refer to FIG. 1) through the front end box 40. The video controlling portion 303 performs image quality adjustment for input video signals and other signal processing depending on the instructions from the controlling portion 302, to write into a video buffer 307. Furthermore, the controlling portion 302 instructs the video controlling portion 303 to draw a cursor into a video based on the operation information from the operating portion 301.

The OSD controlling portion 304 draws an OSD screen to be superimposed on an original video depending on information conveyed from the controlling portion 302, to write into an OSD buffer 308. The OSD screen includes one or more menu button(s) to be selected by a user via the operating portion 301 such as a touch sensor, a sub menu to be pulled down from the menu button(s), thus text information, and the like.

An MISC controlling portion 305 performs OSD control and controls other than the video control depending on the information conveyed from the controlling portion 302.

An image synthesizing portion 309 superimposes the OSD screen written into the OSD buffer 308 on the video data written into the video buffer 307, to output to a display controlling portion 310.

The display controlling portion 310 divides the input video signals into a video signal for the left eye and a video signal for the right eye to control drawings for a left eye display panel 311L and a right eye display panel 311R. The left eye display panel 311L and the right eye display panel 311R are composed of displaying devices such as, for example, organic electro-luminescent (EL) elements and a liquid crystal.

The left eye display panel 311L and the right eye display panel 311R are equipped, respectively, with ocular optical lens portions 312L and 312R for enlarging and projecting videos. Each of the left and right ocular optical lens portions 312L and 312R is composed of a combination of a plurality of lenses, and performs such optical processing as to enlarge and project videos displayed by the left eye display panel 311L and the right eye display panel 311R for the left and right eyes of an observer. The videos displayed on light-emitting faces of the left eye display panel 311L and the right eye display panel 311R are respectively enlarged when they pass through the ocular optical lens portions, to form a large virtual image on retinas of a user. Then, a video for the left eye and a video for the right eye are integrated in the brain of an observing user.

In order to meet the required precision as the head mount display, it is necessary to position and fix the display panels 311L and 311R depending on the optical properties of the ocular optical lens portions 312L and 312R. The positioning precision of the display panels 311L and 311R relative to the ocular optical lens portions 312L and 312R must be at least a pixel size (e.g., 10μ in the case of using organic electro-luminescent (EL) elements) or less.

Here, the optical properties of the ocular optical lens portions 312L and 312R have dispersions within the tolerance with respect to designed values. Also, the pixel positions of the left eye display panel 311L and the right eye display panel 311R have dispersions within the tolerance with respect to panel outer frames to which the display panels 311L and 311R are attached.

Furthermore, when the ocular lens is made of a glass material, it is not possible to directly position and fix the display panel on the ocular lens; it is considered that, usually, a first mechanism component for holding the ocular lens and a second mechanism component for attaching the display panel to the first mechanism component intervene for positioning and fixing the ocular lens and the display panel.

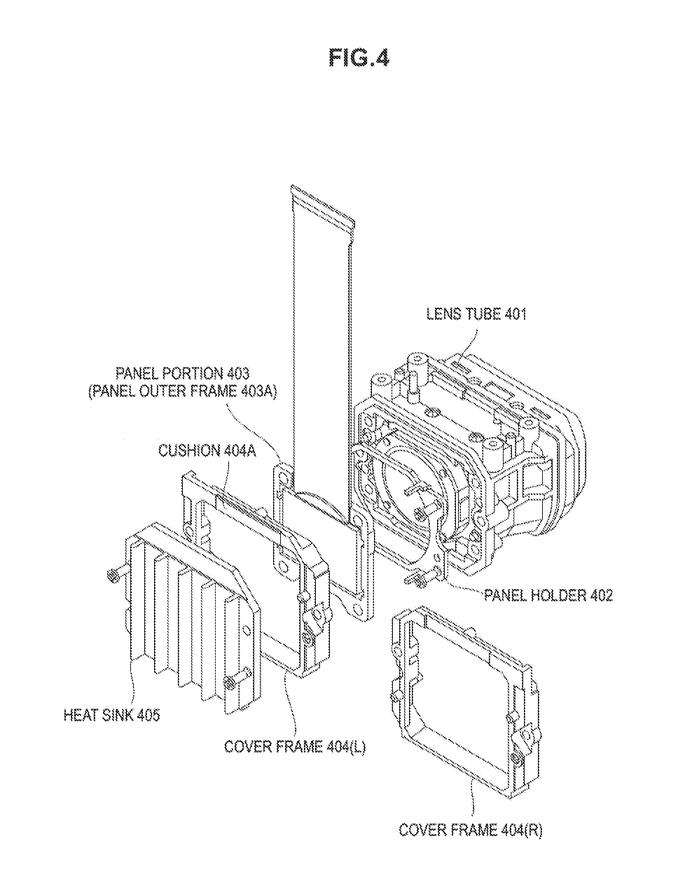

For example, in the specification of Patent Application No. 2011-186622 which has already been assigned to the present applicant, as illustrated in FIG. 4, there is disclosed an optical unit of a head mount unit configured such that a panel portion 403 having the display panel being fixed in advance on a panel outer frame 403A is supported by a panel holder 402, and that the panel holder 402 is attached to a lens tube 401 of the ocular lens.

Since right and left optical units are symmetrical, an optical unit for the left eye is illustrated in FIG. 4, and the illustration of an optical unit for the right eye is omitted. The illustrated optical unit is composed of the lens tube 401 housing a plurality of lenses, the panel holder 402, the panel portion 403 having the display panel being fixed in advance on the panel outer frame 403A, a cover frame 404 for covering the side part of the display panel together with the panel holder 402, and a heat sink 405 composed of a material having a higher heat conductivity.

Four fixing pins are provided at the four corners of the surface of the lens tube 401. However, the optical properties of the lens tube 401 have dispersions (i.e., individual differences) within the tolerance with respect to designed values. Also, the panel holder 402 is screwed to the lens tube 401.

The panel portion 403 is obtained by adhering and fixing the display panel to the panel outer frame 403A in advance. The panel outer frame 403A has fixing holes being bored, through which each of the fixing pins (mentioned above) fixed on the lens tube 401 are inserted. The display panel is composed of displaying elements such as organic electro-luminescence (EL), and the panel outer frame 403A is composed of a substrate, Flexible Printed Circuits (FPC), on which the display panel is mounted. The pixel position of the display panel has dispersions within the tolerance with respect to the panel outer frame 403A.

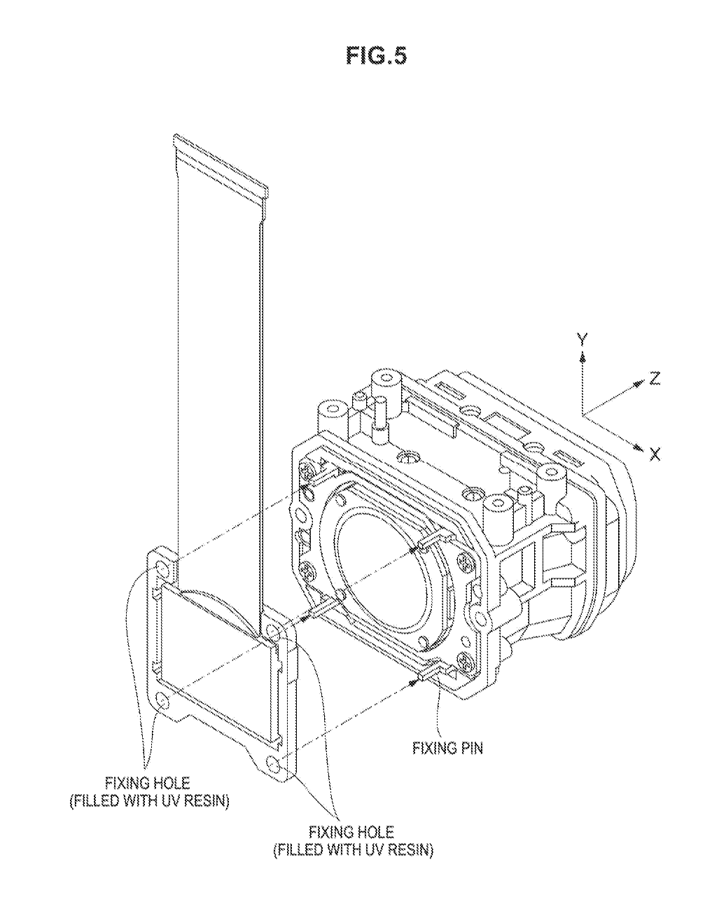

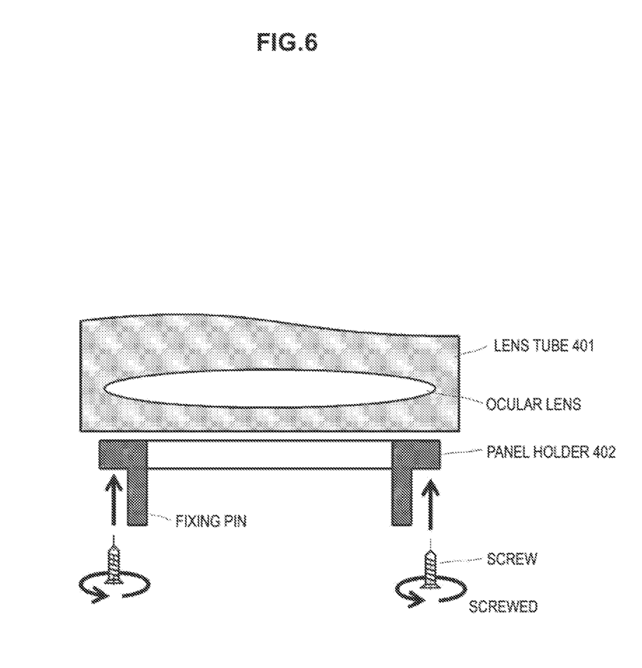

FIG. 5 diagrammatically illustrates the appearance in which the respective fixing pins of the panel holder 402 are inserted, respectively, through the corresponding fixing holes of the panel portion 403 side. Furthermore, FIGS. 6 to 9 diagrammatically illustrate the procedure in which the panel portion 403 is positioned and fixed to the lens tube 401 housing the ocular lens via the panel holder 402.

First, as illustrated in FIG. 6, the panel holder 402 is attached to the surface of the lens tube 401 with four screws at four corners. In this state, the fixing pins of the panel holder 402 are protruded to the opposite side of the lens tube 401.

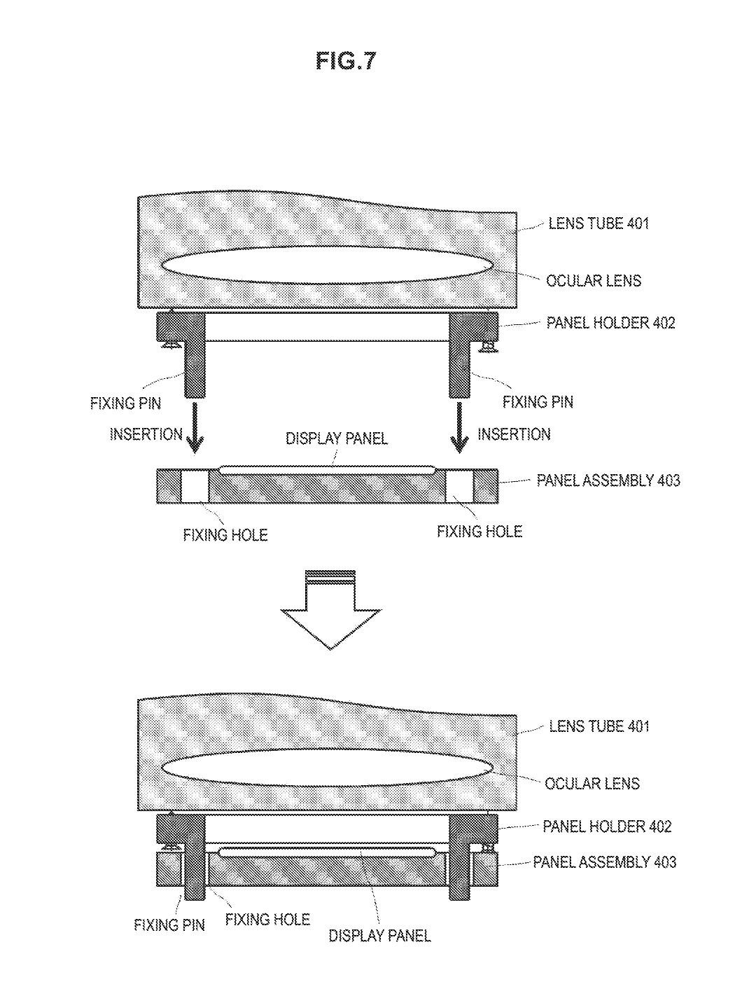

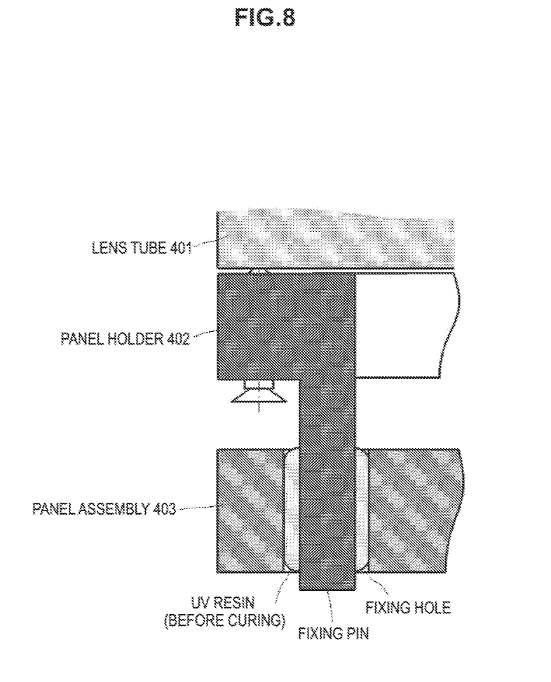

Next, as illustrated in FIG. 7, the respective fixing pins of the panel holder 402 screwed to the surface of the lens tube 401 are inserted, respectively, through the corresponding fixing holes of the panel portion 403 side on which the display panel is mounted. Then, as illustrated in FIG. 8, a UV resin is poured into each of the fixing holes to fill the gap relative to the fixing pin. In this state, while varying the position of the display panel in six-axial directions of X, Y and Z axes as well as roll, pitch and yaw via the panel portion 403, the display panel is positioned relative to the optical axis of the lens tube 401, in accordance with individual dispersions within the tolerance of the optical properties of the lens tube 401 and with individual dispersions of the pixel position of the display panel relative to the panel outer frame 403A. Positioning of the display panel relative to the optical axis of the lens tube 401 is performed with the precision of a pixel size or less, for example.

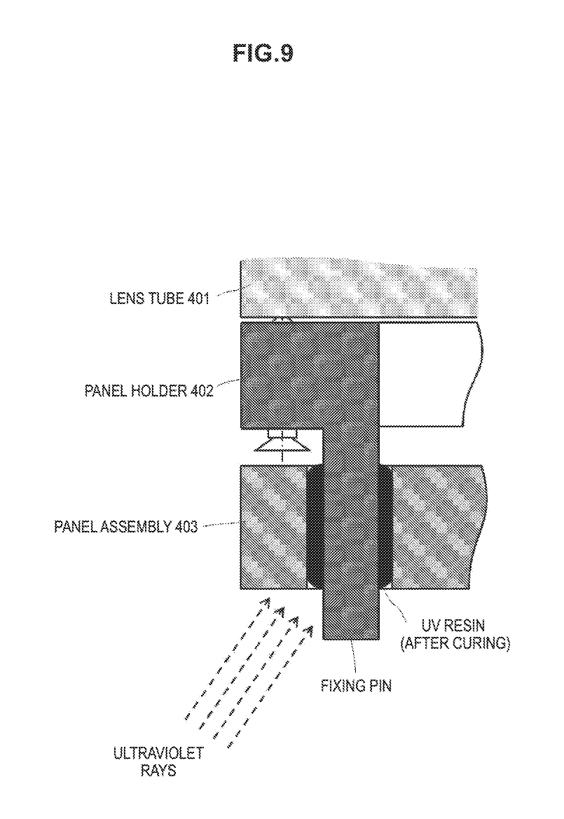

Then, when the position of the display panel relative to the lens tube 401 is determined, as illustrated in FIG. 9, a location near each of the fixing pins is irradiated with ultraviolet rays to cure the UV resin having filled the gap relative to the fixing pin, thereby enabling the display panel to be fixed at a desired position relative to the lens tube 401.

In the case of the positioning and fixing method with the panel holder 402 intervening as illustrated in FIGS. 4, 5, and 6 to 9, a positioning element (positioning hole) and a fixing means (four screws) relative to the lens tube 401 are necessary. Also, the panel holder 402 is a high value-added component with precision management being required, causing increased costs. The panel holder 402 is, for example, a metal-pressed product, and requires surface treatment (or matte coating) for preventing unnecessary light reflection. It is concerned that, when the panel holder 402 is screwed to the lens tube 401, fine bare metal shavings or dust due to plating may occur, causing dust of this kind to be adhered to an effective display area of the display panel.

In addition, when the display panel is positioned with the panel holder 402 intervening, it becomes difficult to make the lens tube 401 more compact and lightened, due to conditions such as: (1) spaces for disposing a positioning element and a fixing element are required; and (2) the center position of each of the fixing pins must be coincident with that of the corresponding fixing hole of the panel portion 403 side. Also, when the UV resin having filled the fixing hole is cured, the shade of the fixing pin prevents the UV resin from being irradiated, causing insufficient curing. In order to cure the UV resin evenly, there is no other choice but to irradiate ultraviolet rays from above the fixing pin so as not to shade it.

Then, the present applicant proposes a method in which an attachment portion for positioning and fixing a display panel (specifically, a panel portion on which the display panel is mounted) is provided integrally with an ocular optical lens portion, so that the display panel is directly attached to the ocular optical lens portion without a component such as the panel holder 402 intervening.

Specifically, at least one lens constituting the ocular optical lens portion is employed as a transparent resin-molded lens, and a fixing pin as the attachment portion of the display panel is integrally molded with this transparent resin-molded lens. The ocular optical lens portion is usually composed of a plurality of lenses; if all of these are made to be resin-molded products, then the ocular optical lens portion can be light weigh with less cost.

Here, examples of lens materials include transparent thermoplastic resins (e.g., Cyclic Olefin Polymer (COP), PolyCarbonate (PC), Poly Methyl MethAcrylate (PMMA), Methylmethacrylate Styrene copolymerization (MS) resins, and the like) to be used for optical applications.

When two or more lenses inside the ocular optical lens portion are made to be resin-molded products, the fixing pin may be integrally molded with either of these resin-molded lenses. However, taking account of operabilities such as easy assembly and attaching position adjustment, it is preferable that a lens which is the most adjacent (i.e., the most external) to the display panel is integrally molded with the fixing pin.

Furthermore, in order not to prevent the observation of a displayed video on the display panel due to formation of the fixing pin on the lens surface, it is necessary to determine a position at which a fixing pin is disposed, taking full account of the optical properties of the ocular optical lens portion. That is, it is preferable to provide a fixing pin at a location where no light of a video displayed on the effective area of the display panel passes through. Also, taking account of the operabilities, or the like to allow the center position of each of the fixing pins to be coincident with that of the corresponding fixing hole of the panel portion side, it is preferable to dispose the respective fixing pins at locations that are symmetrical with respect to the center of the optical axis of the resin-molded lens.

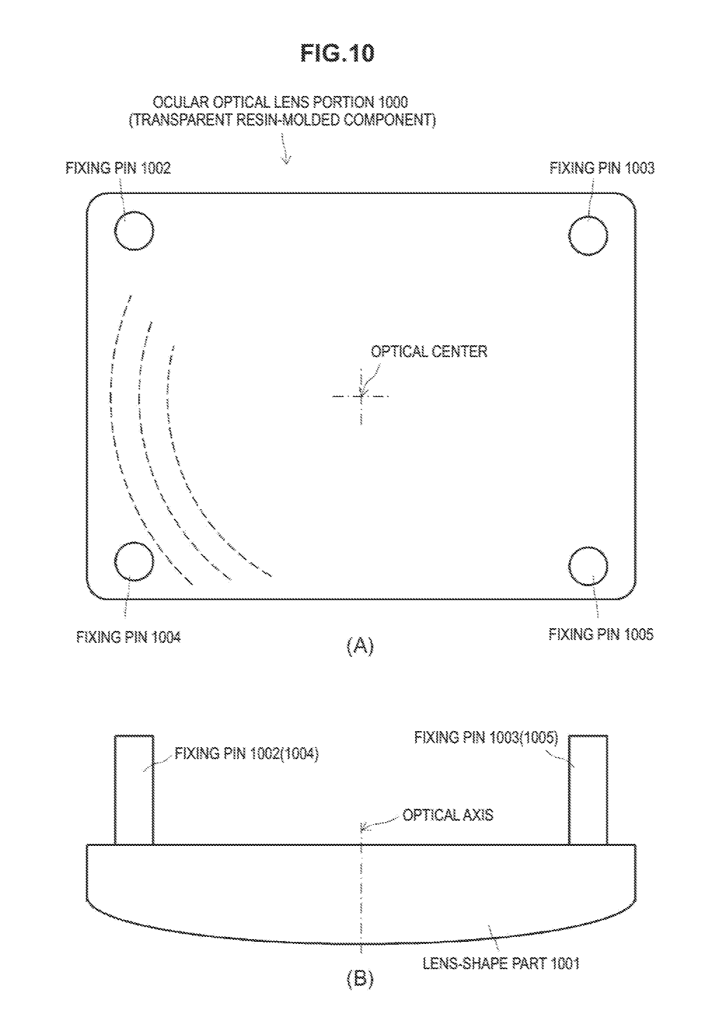

FIG. 10 illustrates a top view (refer to FIG. 10(A)) and a side view (refer to FIG. 10(B)) of the transparent resin-molded lens with each of the fixing pins being integrally molded therewith at locations not interfering with optical properties of the ocular optical lens portion and being symmetrical with respect to the center of the optical axis of the ocular optical lens portion.

On one surface (bottom face side in FIG. 10(B)) of a transparent resin-molded component 1000 forming a rectangular contour, a lens portion 1001 is provided which has a spherical or aspherical lens shape so as to obtain optical properties as an ocular optical lens. The lens portion 1001 has an optical center around approximately the center of the rectangle. A light of a video displayed on the effective area of the display panel passes through the lens portion 1001 to be enlarged and projected in the eyes of an observer.

Furthermore, the other surface (top face side in FIG. 10(B)) of the transparent resin-molded component 1000 has an approximately flat shape, and fixing pins 1002, 1003, 1004 and 1005 are protruded at the four corners of this surface. These four fixing pins 1002 to 1005 are disposed at locations where no light of a video displayed on the effective area of the display panel passes through, so that observation of a video on the display panel is not hampered. Also, at locations that are symmetrical with respect to the optical center of the lens portion 1001, a group of the fixing pin 1002 and the fixing pin 1005 and a group of the fixing pin 1003 and the fixing pin 1004 are respectively provided.

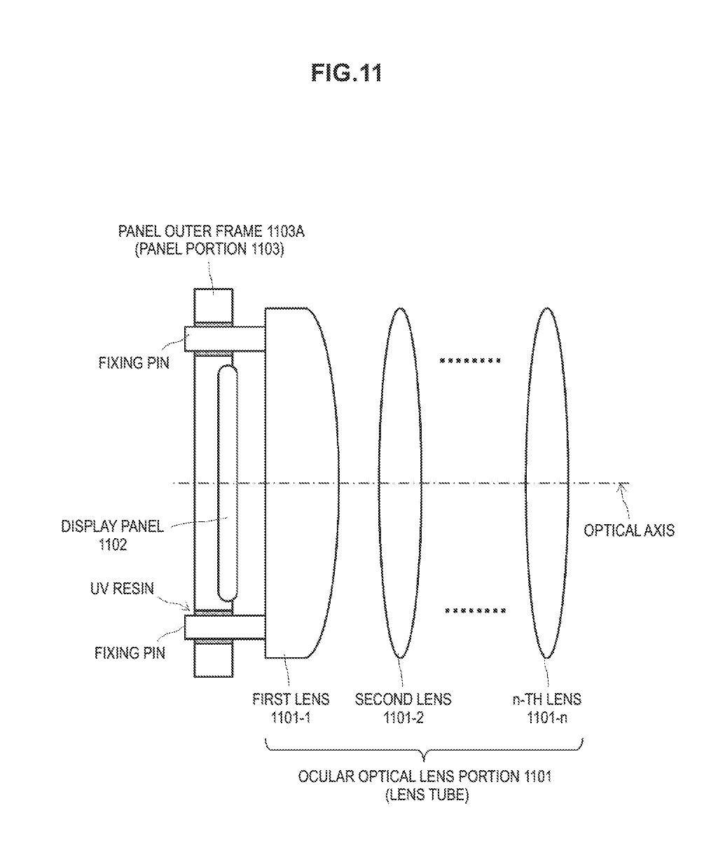

Furthermore, FIG. 11 illustrates the sectional configuration of an ocular optical lens portion 1101 in a state where fixing pins are formed on a transparent resin-molded lens which is the most adjacent to the display panel and a panel portion is directly attached to the fixing pins.

A display panel 1102 is mounted on a panel outer frame 1103A made of PolyCarbonate (PC), to constitute a panel portion 1103. Also, on the panel outer frame 1103A, fixing holes are bored at locations corresponding to the respective fixing pins integrally molded with a first lens 1101-1.

The ocular optical lens portion 1101 has the total of n pieces of transparent resin-molded lenses of the first lens 1101-1, a second lens 1101-2, . . . , and an n-th lens 1101-n, and these are positioned and supported by a lens tube that is not illustrated so as to obtain a desired optical properties (the optical axes of the respective lenses are supposed to be coincident with each other).

The first lens 1101-1 is disposed at a location which is the most adjacent (i.e., the most external) to the display panel. On one surface of the first lens 1101-1, a spherical or aspherical lens shape is formed, in order to obtain desired optical properties. Also, on the other surface (display panel 1102 side) of the first lens 1101-1, fixing pins are integrally molded. As has already been explained with reference to FIG. 10, the respective fixing pins of the first lens 1101-1 do not interfere with the optical properties of the ocular optical lens portion 1101, and are provided at four corners so as to be symmetrical with respect to the optical axis.

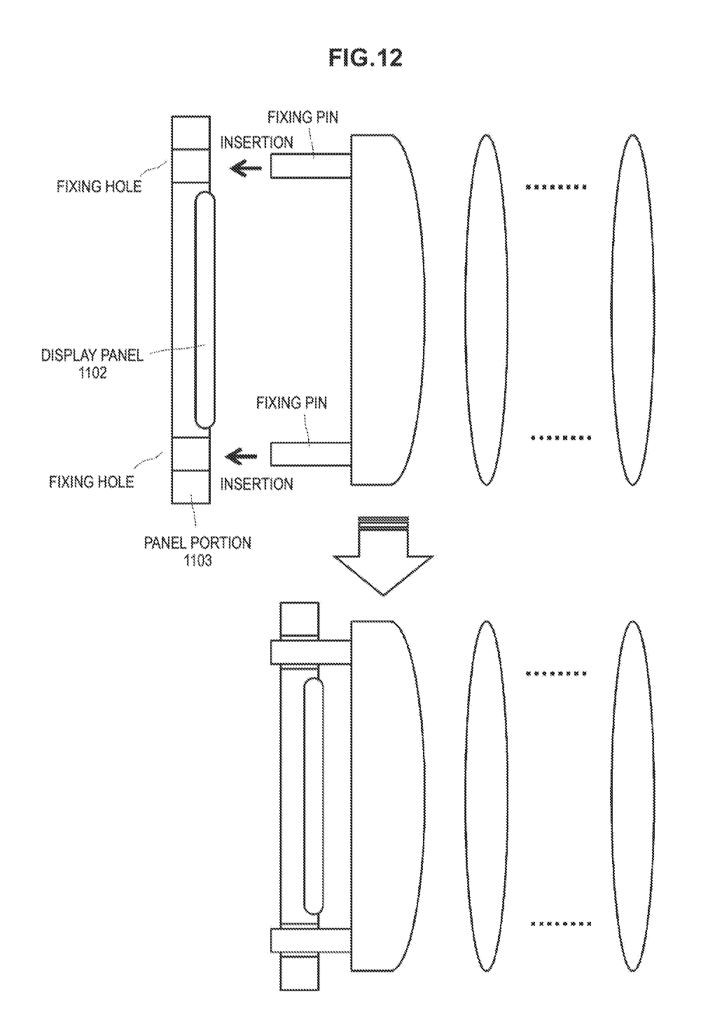

Here, a method for attaching the display panel will be explained with reference to FIGS. 12 to 14.

First, as illustrated in FIG. 12, the respective fixing pins integrally molded with the first lens 1101-1 are respectively inserted through the corresponding fixing holes of the panel outer frame 1103A side, to directly attach the display panel 1102 to the first lens 1101-1 together with the panel portion 1103. The attachment of the panel portion 1103 does not involve a screwing operation using screws, and thus there is no concern for occurrence of dust.

Then, in a state where the panel portion 1103 is attached to the first lens 1101-1, while varying the position of the display panel 1102 in six-axial directions of X, Y and Z axes as well as roll, pitch and yaw, the display panel 1102 is positioned, in accordance with individual dispersions within the tolerance of the optical properties of the ocular optical lens portion 1101 and with individual dispersions of the pixel position of the display panel 1102 relative to the panel outer frame 1103A. Positioning of the display panel 1102 relative to the optical axis of the ocular optical lens portion 1101 is performed with the precision of a pixel size or less, for example.

For example, while allowing the display panel 1102 to display such a light-emitting pattern as to enable to recognize a spatial position and posture of the display panel 1102 and recognizing this in the filmed image of a camera (not illustrated), the relative position of the display panel 1102 relative to the ocular optical lens portion 1101 is adjusted in six-axial directions.

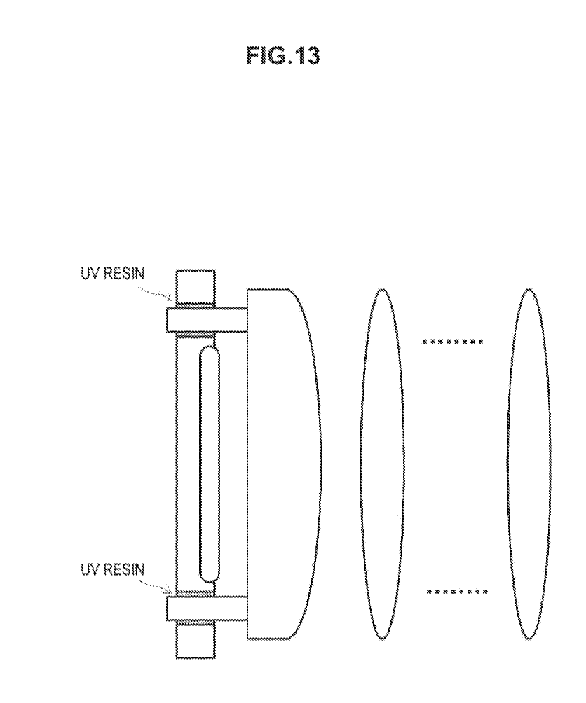

Then, when the position of the display panel 1102 relative to the ocular optical lens portion 1101 is determined, with the position being maintained, as illustrated in FIG. 13, a UV resin is poured into each of the fixing holes to fill the gap relative to the fixing pin. However, it is also possible to perform an operation to insert the fixing pin as illustrated in FIG. 12 after the fixing holes are filled with the UV resin in advance.

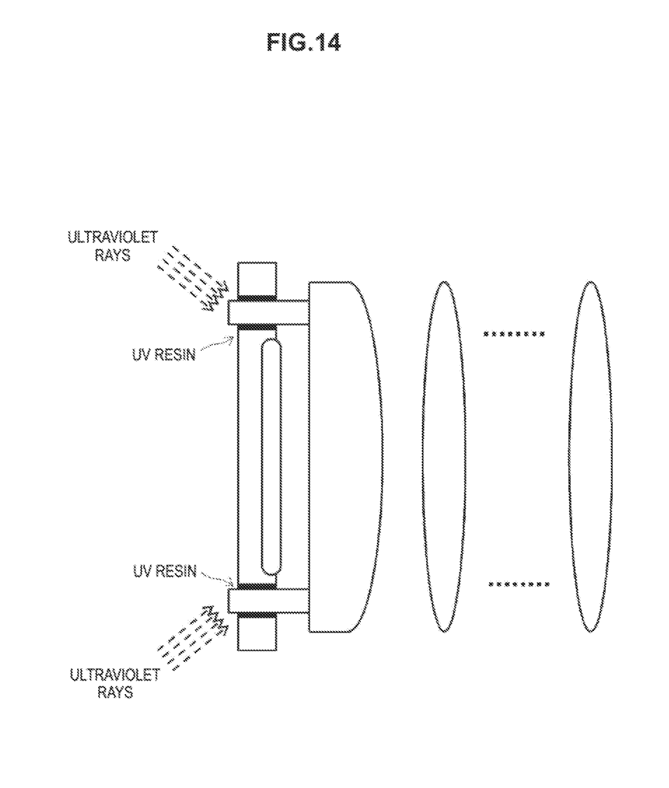

Next, as illustrated in FIG. 14, a location near each of the fixing pins is irradiated with ultraviolet rays to cure the UV resin having filled the gap relative to the fixing pin, thereby fixing the display panel 1102 at a desired position relative to the ocular optical lens portion 1101. Each of the fixing pins is integrally molded with the transparent resin-molded lens, which means that it has transparency. Therefore, there is a merit in which, when the UV resin is irradiated with ultraviolet rays, the fixing pin is not shaded, facilitating setting of curing condition and management. For example, even if ultraviolet rays are irradiated from the side of the fixing pin, the UV resin can be cured evenly.

Materials for each of the lenses used in the ocular optical lens portion 1101 are transparent thermoplastic resins (e.g., Cyclic Olefin Polymer (COP), PolyCarbonate (PC), Poly Methyl MethAcrylate (PMMA), Methylmethacrylate Styrene copolymerization (MS) resins, and the like) used for optical applications, and have a linear expansion coefficient close to that of the panel outer frame 1103A made of PolyCarbonate (PC), or the like. Therefore, a relative displacement variation with respect to temperature change is equal to approximately zero between the fixing hole of the panel outer frame 1103A and the fixing pin of the lens 1101-1 side.

In contrast, as illustrated in FIGS. 4 to 9, in the case of the structure in which the display panel is attached to the lens tube 401 via the panel holder 402, a relative expansion/shrinkage difference between the panel holder 402 made of a metal material and the panel outer frame 403A employing PolyCarbonate (PC) as a material is 0.02 mm, which is not small (provided that the difference at the time of fluctuation at 40° C. is indicated, and the distance between the lens center and the fixing pin is supposed to be 13 mm) Therefore, it is necessary to devise ways to suppress relative displacement variation with respect to temperature change between the panel outer frame 403A (i.e., display panel) and the center of the optical axis of the lens.

As described above, according to the technology disclosed in the present specification, the attachment portion such as the fixing pin for attaching the panel holder 402, namely, the display panel is integrally molded with the ocular lens which is an injection-molded product, and thus it can be said that the shaping flexibility of a holding structure is improved.

Furthermore, according to the attachment structure of the display panel as illustrated in FIGS. 10 to 14, it becomes unnecessary to allow a mechanism component such as the panel holder 402 to intervene. Therefore, it becomes possible to reduce the weight and costs of the panel holder 402 component as well as the operating costs of screwing the panel holder 402 to the lens tube 401. Since the same holds true for the right and left display panels, the effects of reduced weight and costs are doubled. Also, the occurrence of dust accompanying screwing of the panel holder 402 is eliminated, and thus there will also be no concern for the effective display area of the display panel being contaminated due to dust adhesion.

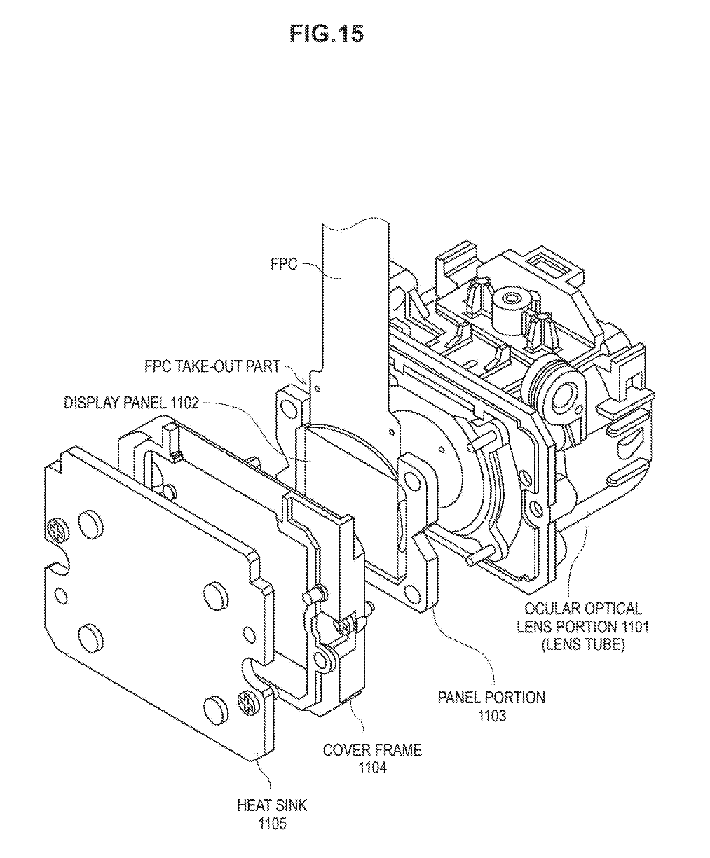

It is noted that, if foreign matters such as dirt adheres to the surface of the display panel 1102, it is enlarged by a lens to be observed by a user, resulting in degraded image quality, which causes commercial value to be impaired. Therefore, it is necessary to have a dust-proof structure for sealing the light-emitting face of the display panel 1102. This dust-proof structure will be explained with reference to FIG. 15. In FIG. 15, the sealing structure for protecting the light-emitting face of the display panel from dust is mainly composed of three articles of a lens tube of the ocular optical lens portion 1101, a cover frame 1104, and a heat sink 1105.

The lens tube of the ocular optical lens portion 1101 and the cover frame 1104 are in close contact with each other without any gap on a face opposite to each other. Also, the cover frame 1104 and the heat sink 1105 are in close contact with each other on a face opposite to each other. Here, a Flexible Printed Circuit (FPC) take-out part of the display panel 1102 on the backside of the cover frame 1104 has a cushion material (not illustrated) being stuck thereon for alleviating external load on the Flexible Printed Circuit (FPC), so as to have a structure to press the Flexible Printed Circuit (FPC) via the cushion material. The assembly operation as described above is performed inside a clean booth; it is preferable to prevent dust from entering at the time of assembly and from being adhered to the light-emitting face of the display panel 1102. Also, after completion of the assembly, the light-emitting face of the display panel 1102 comes to have a dust-proof structure.

Furthermore, for the displaying portion of the head mount unit 10, slim type display elements are used such as the aforementioned organic electro-luminescent (EL) elements and liquid crystal display. It has been known that a display panel produced with this kind of semiconductor process entails heat generation depending on power consumption. On the other hand, it is considered that, since maximum drive temperature of the display panel is determined, the display panel incorporated into the head mount unit 10 needs to be managed within the maximum drive temperature.

In the present embodiment, as illustrated in FIG. 15, the display panel 1102 has a cooling structure such that heat is exhausted from the surface (i.e., backside of the light-emitting face) of the substrate side through the heat sink 1105. Here, the height of the cover frame 1104 in the optical axial direction is made to be such a size as to have a space between the backside of the display panel 1102 and the heat sink 1105 when the heat sink 1105 is attached. Before the attachment, a gap between the backside of the display panel 1102 and the heat sink 1105 which are opposite to each other is filled with a heat conductive grease. Also, when assembling, a suitable amount of the heat conductive grease is applied in advance to the backside of the display panel 1102 or the heat sink 1105. Therefore, when the heat sink 1105 is attached, the heat conductive grease is spread, to be in such a state that a certain area between the backside of the display panel 1102 and the heat sink 1105 is filled therewith. Here, as the heat conductive grease, it is preferable to use the one having an appropriate viscosity and thixotropy so as not to be dripped or flowed out from the gap.

Furthermore, while six-axial adjustment/fixing of the display panel 1102 causes occurrence of size dispersions in the position of the display panel 1102 relative to the heat sink 1105, the cooling structure using the illustrated heat sink 1105 and the heat conductive grease also has an effect of being able to absorb the size dispersions.

Additionally, the present technology may also be configured as below.
(1)

A head-mounted display apparatus including:

a display panel portion including a display panel configured to display an image;

an ocular optical portion having a lens integrally formed with an attaching part to which the display panel portion is attached, and configured to perform optical processing for a video displayed by the display panel;

a video signal processing portion configured to process a video signal; and

a display controlling portion configured to drive the display panel based on the video signal processed at the video signal processing portion.
(2)

The head-mounted display apparatus according to (1),

wherein the lens having the attaching part is made of a transparent resin-molded lens, with which the attaching part is integrally molded.
(3)

The head-mounted display apparatus according to (2),

wherein the attaching part includes a plurality of fixing pins integrally molded with the transparent resin-molded lens, and

wherein the fixing pin is inserted through a fixing hole bored on a side of the display panel portion to attach the display panel portion to the ocular optical portion.
(4)

The head-mounted display apparatus according to (3),

wherein the fixing pin is provided at a location where no light of a video displayed on an effective area of the display panel passes through on a surface of the transparent resin-molded lens.
(5)

The head-mounted display apparatus according to (3),

wherein the plurality of fixing pins are provided at locations that are symmetrical with respect to an optical center of the transparent resin-molded lens.
(6)

The head-mounted display apparatus according to (1),

wherein the ocular optical portion has a plurality of lenses, and the lens which is integral with the attaching part is the most adjacent to the display panel.
(7)

The head-mounted display apparatus according to (1), further including:

a display panel cooling portion configured to cool the display panel.
(8)

The head-mounted display apparatus according to (7),

wherein the display panel cooling portion has a heat sink configured to be brought into surface contact with a substrate side of the display panel.
(9)

The head-mounted display apparatus according to (8), further including:

a heat conductive grease configured to fill a gap that occurs at a time of bringing the heat sink into surface contact with the substrate side of the display panel.
(10)

The head-mounted display apparatus according to (1), further including:

a display panel sealing portion configured to seal a light-emitting face of the display panel.
(11)

The head-mounted display apparatus according to (10),

wherein the display panel sealing portion has a cover frame configured to cover a side part of the display panel fixed by the display panel holding portion, and a lid portion configured to close an opening of the cover frame.
(12)

The head-mounted display apparatus according to (11),

wherein the lid portion is the heat sink configured to be brought into surface contact with a substrate side of the display panel.
(13)

The head-mounted display apparatus according to (12), further including:

a heat conductive grease configured to fill a gap that occurs at a time of bringing the heat sink into surface contact with the substrate side of the display panel.
(14)

An optical unit for a head-mounted display apparatus including:

a display panel portion including a display panel configured to display an image; and

an ocular optical portion having a lens integrally formed with an attaching part to which the display panel portion is attached, and configured to perform optical processing for a video displayed by the display panel.

### INDUSTRIAL APPLICABILITY

It should be understood by those skilled in the art that various modifications, combinations, sub-combinations and alterations may occur depending on design requirements and other factors insofar as they are within the scope of the appended claims or the equivalents thereof.

In the present specification, explanation of the technology disclosed in the present specification has been centered on the embodiments applied on the head mount display composed of the front end box and the head mount unit, whilst the gist of the technology disclosed in the present specification is not limited to the configuration of a specific head mount display. The technology disclosed in the present specification can apply as well to various types of display apparatuses in which a display panel and an optical system are integrated.

In short, the technology disclosed in the specification has been described in a form of illustration and should not be interpreted limitedly. To determine the gist of the technology disclosed in the present specification, patent claims should be taken into account.

### REFERENCE SIGNS LIST

10 head mount unit
20 Blu-ray disc reproducing apparatus
30 high-vision display
40 front end box
301 operating portion
302 controlling portion
303 video controlling portion
304 OSD controlling portion
305 MISC controlling portion
306 video input interface
307 video buffer
308 OSD buffer
309 image synthesizing portion
310 display controlling portion
311L left eye display panel
311R right eye display panel
312L left eye ocular optical lens portion
312R right eye ocular optical lens portion
401 lens tube
402 panel holder
403 panel portion
404 cover frame
405 heat sink
1000 transparent resin-molded component
1001 lens portion
1002-1005 fixing pin
1101 ocular optical portion
1101-1-1101-n lens
1102 display panel
1103 panel portion
1103A panel outer frame
1104 cover frame
1105 heat sink

1. A head-mounted display apparatus comprising:
a display panel portion including a display panel configured to display an image;
an ocular optical portion having a lens integrally formed with an attaching part to which the display panel portion is attached, and configured to perform optical processing for a video displayed by the display panel;
a resin configured to fill a gap between the display panel portion and the attaching part, and configured to be cured after the display panel portion and the lens are positioned;
a video signal processing portion configured to process a video signal; and
a display controlling portion configured to drive the display panel based on the video signal processed at the video signal processing portion.

2. The head-mounted display apparatus according to claim 1,
wherein the lens having the attaching part is made of a transparent resin-molded lens, with which the attaching part is integrally molded.

3. The head-mounted display apparatus according to claim 2,
wherein the display device is configured to emit a display light including an S polarization component,
wherein the attaching part includes a plurality of fixing pins integrally molded with the transparent resin-molded lens,
wherein the fixing pin is inserted through a fixing hole bored on a side of the display panel portion to attach the display panel portion to the ocular optical portion.

4. The head-mounted display apparatus according to claim 3,
wherein the fixing pin is provided at a location where no light of a video displayed on an effective area of the display panel passes through on a surface of the transparent resin-molded lens.

5. The head-mounted display apparatus according to claim 3,
wherein the plurality of fixing pins are provided at locations that are symmetrical with respect to an optical center of the transparent resin-molded lens.

6. The head-mounted display apparatus according to claim 1,
wherein the ocular optical portion has a plurality of lenses, and the lens which is integral with the attaching part is the most adjacent to the display panel.

7. The head-mounted display apparatus according to claim 1, further comprising:
a display panel cooling portion configured to cool the display panel.

8. The head-mounted display apparatus according to claim 7,
wherein the display panel cooling portion has a heat sink configured to be brought into surface contact with a substrate side of the display panel.

9. The head-mounted display apparatus according to claim 8, further comprising:
a heat conductive grease configured to fill a gap that occurs at a time of bringing the heat sink into surface contact with the substrate side of the display panel.

10. The head-mounted display apparatus according to claim 1, further comprising:
a display panel sealing portion configured to seal a light-emitting face of the display panel.

11. The head-mounted display apparatus according to claim 10,
wherein the display panel sealing portion has a cover frame configured to cover a side part of the display panel fixed by the display panel holding portion, and a lid portion configured to close an opening of the cover frame.

12. The head-mounted display apparatus according to claim 11,
wherein the lid portion is the heat sink configured to be brought into surface contact with a substrate side of the display panel.

13. The head-mounted display apparatus according to claim 12, further comprising:
a heat conductive grease configured to fill a gap that occurs at a time of bringing the heat sink into surface contact with the substrate side of the display panel.

14. An optical unit for a head-mounted display apparatus comprising:
a display panel portion including a display panel configured to display an image;
an ocular optical portion having a lens integrally formed with an attaching part to which the display panel portion is attached, and configured to perform optical processing for a video displayed by the display panel, and
wherein the resin is poured into a gap between the fixing pin and the fixing hole for filling, and is cured after the display panel portion and the transparent resin-molded lens are positioned.

15. The head-mounted display apparatus according to claim 1,
wherein the display panel portion includes a display panel and a panel outer frame configured to mount the display panel, and
wherein the lens is attached to the display panel portion via the panel outer frame, and has a linear expansion coefficient close to the panel outer frame.

16. The head-mounted display apparatus according to claim 15,
wherein the panel outer frame is made of PC (polycarbonate).

17. The head-mounted display apparatus according to claim 1,
wherein the resin is made of a UV resin, and is cured with irradiation of ultraviolet rays after the display panel portion and the lens are positioned.
